(19) United States
(12) Patent Application Publication
(10) Pub. No.: US 2014/0229436 A1
(43) Pub. Date: Aug. 14, 2014

(54) Method of File Synchronization and Electronic Device Thereof

(71) Applicant: Wistron Corporation, New Taipei City (TW)

(72) Inventors: Fuming Wang, New Taipei City (TW); Hung-Pin Lai, New Taipei City (TW)

(73) Assignee: Wistron Corporation, New Taipei City (TW)

(21) Appl. No.: 14/074,732

(22) Filed: Nov. 8, 2013

(30) Foreign Application Priority Data
Feb. 8, 2013 (CN) 201310050905.5

(51) Int. Cl. G06F 17/30

(52) U.S. Cl. CPC G06F 17/30581
USPC 707/622

(57) ABSTRACT

A method of file synchronization for a first electronic device offline logging into a local area network is disclosed. The method includes searching for at least one second electronic device logging into the local area network, transmitting a first operational serial number to the second electronic device and receiving a second operational serial number from the second electronic device, determining one of the first and second electronic devices as a temporary server according to the first operational serial number and the second operational serial number, and performing file synchronization with the temporary server.

### BACKGROUND OF THE INVENTION

1. Field of the Invention

The present invention relates to a method of file synchronization and electronic device thereof, and more particularly, to a method of file synchronization and electronic device thereof offline logging into a local area network.

2. Description of the Prior Art

An online storing service provider (hereinafter called a server) may provide cloud storage and file synchronization service to users, and the user may store and access data stored in the cloud storage at any time and location by the Internet.

Further, more and more users, such as enterprise, family or personal users, may own multiple electronic devices including a personal computer, a tablet PC, a smart phone and a personal digital assistant, so the users may access data stored in the cloud storage at home or office by different electronic devices as needed.

However, file synchronization is performed only when the electronic device is connected with the server, otherwise file synchronization will be stopped. Besides, if the user uses different electronic devices to access the server, each of the electronic devices will respectively perform file synchronization with the server. As a result, the data stored in the cloud storage may be repeatedly downloaded by the electronic devices, which may increase a total amount of network flow, a cost for data download as well as bandwidth occupation. Therefore, there is a need to improve the prior art.

### SUMMARY OF THE INVENTION

It is therefore an object of the present invention to provide a method of file synchronization and electronic device thereof to offline log into a local area network and perform file synchronization.

The present invention discloses a method of file synchronization for a first electronic device offline logging into a local area network, comprising searching for at least one second electronic device logging into the local area network, transmitting a first operational serial number to the second electronic device and receiving a second operational serial number from the second electronic device, determining one of the first and second electronic devices as a temporary server according to the first operational serial number and the second operational serial number, and performing file synchronization with the temporary server.

The present invention further discloses a first electronic device offline login for a local area network, comprising a processor, and a storage coupled to the processor for storing a program code to instruct the processor executing a method of file synchronization, wherein the method of file synchronization comprises searching for at least one second electronic device logging into the local area network, transmitting a first operational serial number to the second electronic device and receiving a second operational serial number from the second electronic device, determining one of the first and second electronic devices as a temporary server according to the first operational serial number and the second operational serial number, and performing file synchronization with the temporary server.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a local area network.

FIG. 2 is a schematic diagram of a file synchronization process according to an embodiment of the present invention.

FIG. 3 is a schematic diagram of an electronic device according to an embodiment of the present invention.

### DETAILED DESCRIPTION

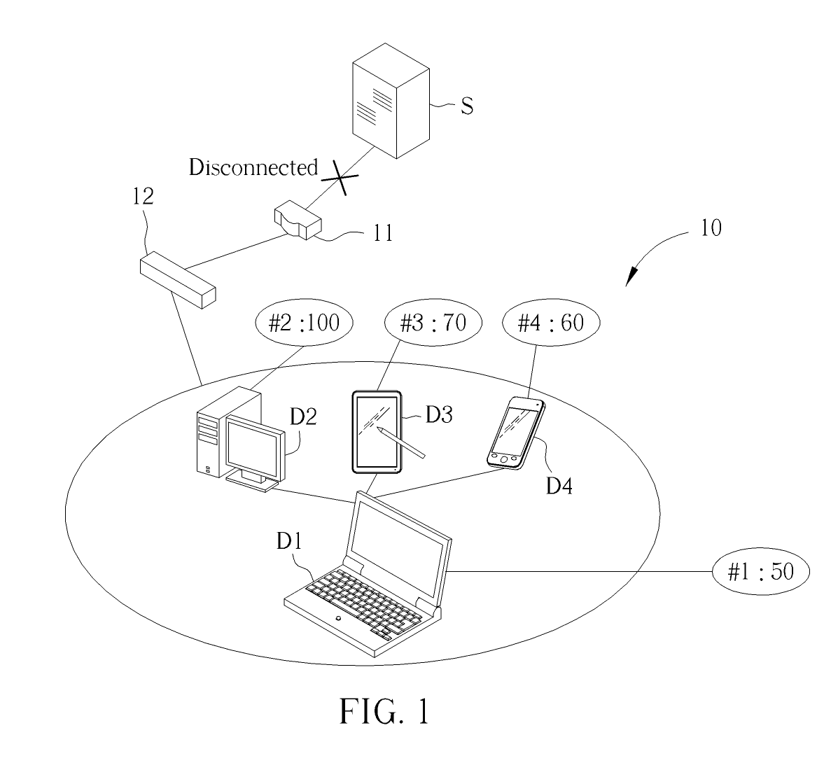

Please refer to FIG. 1, which is a schematic diagram of a local area network 10. The local area network 10 includes a router 11, a switch 12 and electronic devices D1, D2, D3 and D4. The electronic device D1, D2, D3 and D4 may be a device having a function of internet communication. For instance, the electronic devices D1, D2, D3 and D4 shown in FIG. 1 are respectively a notebook computer, a personal computer, a tablet computer and a smart phone. The electronic devices D1, D2, D3 and D4 may connect to a server S through the router 11 and the switch 12. A user may install a file synchronize application in the electronic devices D1, D2, D3 and D4 to log into a user account for a cloud storage provided by the server S to use online storing service. If the user logs into the user account by different electronic device D1, D2, D3 or D4, the electronic device D1, D2, D3 or D4 may respectively perform file synchronization with the server S. However, when the local area network 10 is disconnected from the server S, file synchronizations between the server S and the electronic devices D1, D2, D3 and D4 are stopped.

On the other hand, in practice, each operation of file synchronization corresponding to an operational serial number will be recorded into an operation list when the electronic device performs file synchronization with the server, such that the electronic device may acquire a status of updated file for the next file synchronization according to the operation list. In such a situation, if the user logs into the user account by different electronic device D1, D2, D3 or D4, operation lists respectively recorded in the electronic devices D1, D2, D3 and D4 may not be the same. Normally, for a same user, a same user account or a same sync file, one of the electronic devices D1, D2, D3 and D4 recording the latest operational serial number may be regarded as the electronic device having the latest status of updated file or having a greatest number of updated files.

Therefore, if the electronic device D1, D2, D3 or D4 offline logs into the user account of the server S, the electronic device D2, which has the latest or greatest operational serial number 100, maybe assumed to be a temporary server, and other electronic devices D1, D3 and D4 may down load files from the temporary server D2 to perform file synchronization when the connection with the server S is unavailable. The electronic devices D1, D2, D3 and D4 may communicate with each other by wired or wireless signals, e.g. Bluetooth sharing. As a result, the electronic devices D1, D2, D3 and D4 in the local area network 10 may perform file synchronization even when the connection with the server S is unavailable, which may improve an efficiency of file synchronization in the local area network 10. Besides, updated files stored in the electronic devices D1, D2, D3 and D4 may be shared, which may reduce the total amount of network flow, the cost for data download as well as the bandwidth occupation.

Specifically, take the electronic device D2 as an example, if the router 11 is disconnected from the server S, the electronic device D2 may manually or automatically offline log into the local area network 10 to search for other electronic devices logging into the local area network 10. When the electronic devices D1, D3 and D4 are found, the electronic device D2 may transmit an operational serial number #2 to the electronic devices D1, D3 and D4. The electronic device D2 may receive operational serial numbers #1, #3 and #4 respectively transmitted from the electronic devices D1, D3 and D4. As shown in FIG. 1, assume the operational serial number #1 is 50, which may be regarded that the electronic device D1 has performed fifty updating operations or the electronic device D1 has fifty updated files. Assume the operational serial number #2 is 100, which maybe regarded that the electronic device D2 has performed one hundred updating operations or the electronic device D2 has one hundred updated files. Assume the operational serial number #3 is 70, which may be regarded that the electronic device D3 has performed seventy updating operations or the electronic device D3 has seventy updated files. Assume the operational serial number #4 is 60, which may be regarded that the electronic device D4 has performed sixty updating operations or the electronic device D4 has sixty updated files. In such a situation, the electronic device D1 may determine one of itself and other electronic devices D2, D3 and D4, which has the latest operational serial number, to be a temporary server according to the operational serial numbers #1, #2, #3 and #4. Take the electronic device D1 for example, the electronic device D1 may acquire that the operational serial number #2 of the electronic device D2 is 100, the operational serial numbers #1, #3 and #4 are respectively 50, 70 and 60, wherein the operational serial number #2 is greater than the operational serial numbers #1, #3 and #4, so the electronic device D1 may determine the electronic device D2 has the latest operational serial number #2 to be the temporary server.

When the electronic device D2 is determined to be the temporary server, the electronic device D2 may transmit a file snapshot SNT2 to the electronic devices D1, D3 and D4 as a reference for file synchronization. Meanwhile, the electronic device D2 may select or arrange a priority for performing file synchronization with the electronic device D1, D3 and D4 according to the operational serial number #1, #3 and #4 or connecting conditions of the electronic devices D1, D3 and D4.

On the other hand, when the electronic device D1 determines itself not being the temporary server, the electronic device D1 may receive the file snapshot SNT2 transmitted from the electronic device D2 and by file synchronization to download lacking updated files from the electronic device D2 according to a file snapshot SNT1 and the file snapshot SNT2. During file synchronization with the electronic device D2, the electronic device D1 may record each operation of file synchronization corresponding to an operational serial number. The electronic device D1 may generate a new operational serial number #1-N and a new file snapshot SNT1-N after file synchronization with electronic device D2 is completed. Similarly, operations of the electronic devices D3 and D4 may be obtained by referring to above description, which is omitted.

Furthermore, operations of file synchronization performed by the electronic device D1, D2, D3 and D4 may not be the same, such that the electronic devices D1, D3 and D4 may have updated files which are not stored in the electronic device D2 although the electronic device D2 has the latest file operational serial number. Since the electronic devices D1, D2, D3 and D4 receive file snapshots of each other, the electronic devices D1, D2, D3 and D4 may acquire all statuses of updated files of each other, and the electronic devices D1, D2, D3 and D4 may compare the file snapshots of the electronic devices D1, D2, D3 and D4 to search for file differences between each other. Take the electronic device D2 for example, although the electronic device D2 has the latest file operational serial number #2, the electronic device D2 and the electronic device D1 both perform file snapshots comparison, and discover that a file F-V1 is stored in the electronic device D2, and a file F-V3 is stored in the electronic device D1, wherein a version of file F-V3 is newer than a version of the file F-V1. Thus, the electronic device D2 may know that the electronic device D1 has a newer file F-V3 or the file F-V1 is updated to a newer version. At this moment, the electronic device D2 may regard the electronic device D1 to be the next temporary server with which to perform file synchronization to update the file F-V1 to the file F-V3. Similarly, the electronic devices D3 and D4 may determine the electronic device D1 to be the next temporary server after the file snapshots are compared. Or, the electronic device D2 may transmit a message to the electronic devices D1, D3 and D4 to notify the next temporary server is the electronic device D1. And so forth, since file differences may be discovered by comparing the file snapshots, the electronic devices D3 and D4 may probably be the next temporary server to perform file synchronization afterwards. Simply speaking, the electronic devices D1, D2, D3 and D4 may determine the temporary server by comparing the snapshots to discover their lack of updated files or the latest file version and afterwards perform file synchronization accordingly. Assume the electronic device D1 is determined to be the next temporary server, the electronic device D1 may transmit a new file snapshot SNT1-N to the electronic devices D2, D3 and D4 as a reference for the next file synchronization. As iteratively performing file snapshot comparison, the statuses of updated files of the electronic device D1, D2, D3 and D4 in the local area network 10 maybe completely or nearly the same, which may improve the efficiency of file synchronization of the local area network 10 during offline.

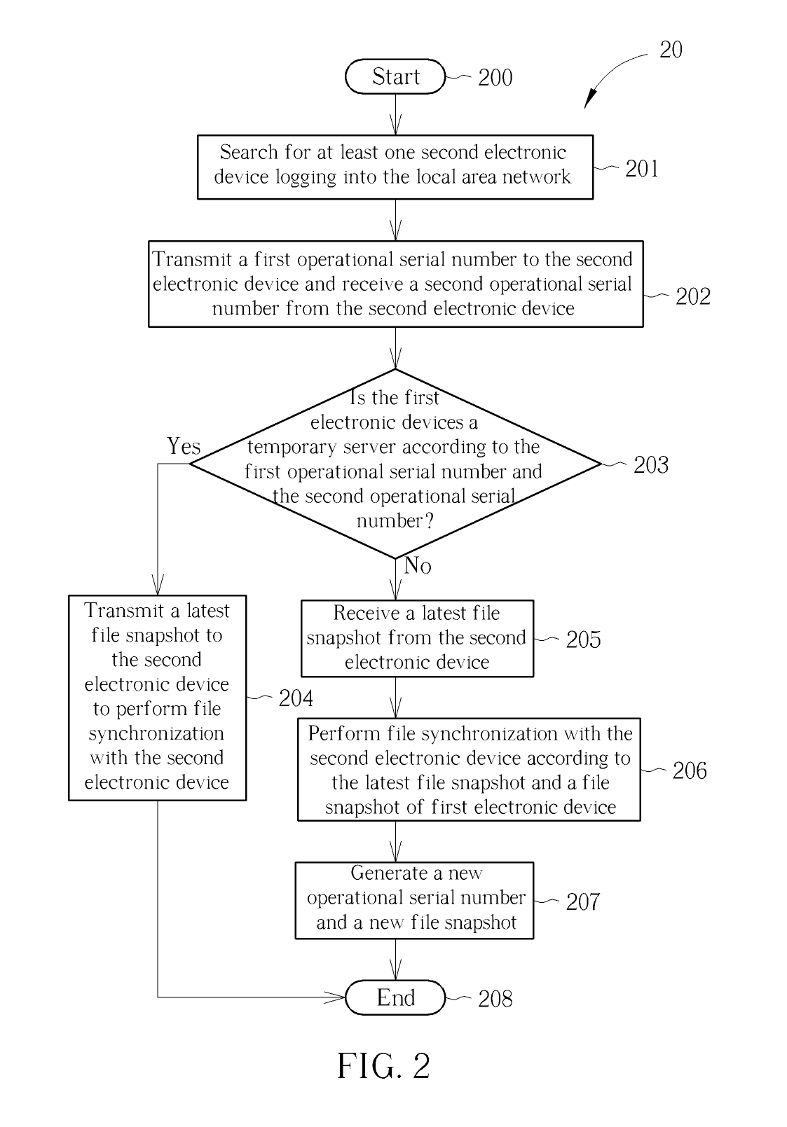

Operations of above description maybe summarized into a file synchronization process 20. Please refer to FIG. 2, which is a schematic diagram of the file synchronization process 20 according to an embodiment of the present invention. The file synchronization process 20 may be utilized in a first electronic device, i.e. the electronic device D1, for performing file synchronization with at least one second electronic device, i.e. the electronic devices D2, D3 and D4, in the local area network 10 during offline. The file synchronization process 20 may be compiled into a program code and include the following steps:

Step 200: Start.

Step 201: Search for at least one second electronic device logging into the local area network.

Step 202: Transmit a first operational serial number to the second electronic device and receive a second operational serial number from the second electronic device.

Step 203: Determine one of the first and second electronic devices as a temporary server according to the first operational serial number and the second operational serial number. Go to step 204 if the first electronic device is the temporary server. Go to step 205 if the first electronic device is not the temporary server.

Step 204: Transmit a latest file snapshot to the second electronic device to perform file synchronization with the second electronic device. End.

Step 205: Receive a latest file snapshot from the second electronic device.

Step 206: Perform file synchronization with the second electronic device according to the latest file snapshot and a file snapshot of first electronic device.

Step 207: Generate a new operational serial number and a new file snapshot.

Step 208: End.

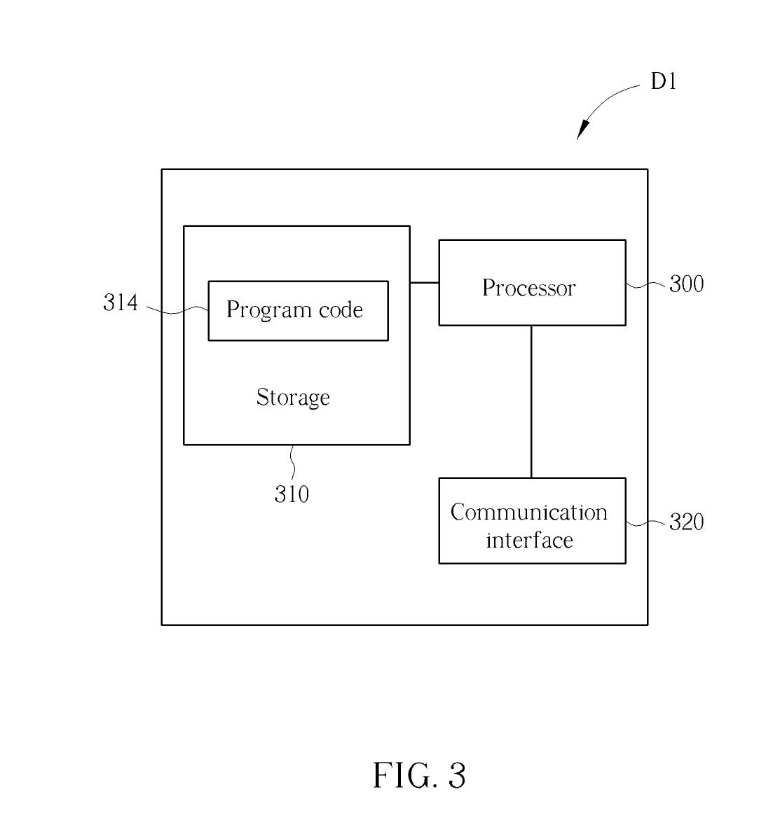

Take the electronic device D1 for example. Please refer to FIG. 3, which is a schematic diagram of the electronic device D1 according to an embodiment of the present invention. The electronic device D1 may be a smart phone, a tablet personal computer, a personal digital assistant or a notebook computer, and the device D1 may connect with the server S to access an on-line storage provided by the server S. The electronic device D1 includes a processor 300, a storage 310 and a communication interface 320. The processor 300 is coupled to the storage 310. The processor 300 may be such as a microprocessor or an application-specific integrated circuit (ASIC). The storage 310 may be any data storage device for storing a program code 314 for the processor 100 to access, and the file synchronization process 20 maybe compiled into the program code 314. For example, the storage 310 may be a subscriber identity module (SIM), a read-only memory (ROM), a random-access memory (RAM), CD-ROMs, magnetic tapes, a hard disk or optical data storage device, and not limited to the mentioned storage devices. The communication interface 320 is used for exchanging data packets with other electronic devices by wired or wireless signals according to processing results of the processor 300.

Detailed operations about the electronic device D1 may be obtained by referring to above description, which is omitted.

To sum up, the electronic devices of the present invention may transmit statuses of file update, e.g. the greatest operational serial numbers, to each other when the electronic devices offline log into the local area network, a temporary server may be determined according to the statuses of file update. Then, the electronic devices other than the temporary server may download updated files from the temporary server by wired or wireless signals, e.g. Bluetooth sharing, to perform file synchronization during offline. As a result, the electronic devices in the local area network may keep performing file synchronization even when the connection with the server is unavailable, which may improve the efficiency of file synchronization of the local area network. Besides, since the electronic device may share updated files with each other, the total amount of network flow, the cost for data download as well as bandwidth occupation may be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of file synchronization for a first electronic device offline logging into a local area network, comprising:
searching for at least one second electronic device logging into the local area network;
transmitting a first operational serial number to the second electronic device and receiving a second operational serial number from the second electronic device;
determining one of the first and second electronic devices as a temporary server according to the first operational serial number and the second operational serial number; and
performing file synchronization with the temporary server.

2. The method of claim 1, wherein the step of determining one of the first and second electronic devices as the temporary server according to the first operational serial number and the second operational serial number comprises:
transmitting a first file snapshot to the second electronic device when the first electronic device is the temporary server.

3. The method of claim 1, wherein the step of determining one of the first and second electronic devices as the temporary server according to the first operational serial number and the second operational serial number comprises:
receiving a second file snapshot from the second electronic device when the first electronic device is not the temporary server; and
performing file synchronization with the second electronic device according to the second file snapshot and a first file snapshot of the first electronic device.

4. The method of claim 3, wherein the step of determining one of the first and second electronic devices as the temporary server according to the first operational serial number and the second operational serial number comprises:
generating a new operational serial number and a new file snapshot.

5. A first electronic device offline login for a local area network, comprising:
a processor; and
a storage coupled to the processor for storing a program code to instruct the processor executing a method of file synchronization, wherein the method of file synchronization comprises:
searching for at least one second electronic device logging in the local area network;
transmitting a first operational serial number to the second electronic device and receiving a second operational serial number from the second electronic device;
determining one of the first and second electronic devices as a temporary server according to the first operational serial number and the second operational serial number; and
performing file synchronization with the temporary server.

6. The first electronic device of claim 5, wherein the step of determining one of the first and second electronic devices as the temporary server according to the first operational serial number and the second operational serial number comprises:
transmitting a first file snapshot to the second electronic device when the first electronic device is the temporary server.

7. The first electronic device of claim 5, wherein the step of determining one of the first and second electronic devices as the temporary server according to the first operational serial number and the second operational serial number comprises:
receiving a second file snapshot from the second electronic device when the first electronic device is not the temporary server; and
performing file synchronization with the second electronic device according to the second file snapshot and a first file snapshot of the first electronic device.

8. The first electronic device of claim 7, wherein the step of determining one of the first and second electronic devices as the temporary server according to the first operational serial number and the second operational serial number comprises:
generating a new operational serial number and a new file snapshot.
